(19) United States
(12) Patent Application Publication
(10) Pub. No.: US 2023/0154487 A1
(43) Pub. Date: May 18, 2023

(54) METHOD, SYSTEM AND DEVICE OF SPEECH EMOTION RECOGNITION AND QUANTIZATION BASED ON DEEP LEARNING

(71) Applicants: Chu-Ying HUANG, Kaohsiung City (TW); Lien-Cheng CHANG, Taipei City (TW); Shuo-Ting HUNG, Taoyuan City (TW); Hsuan-Hsiang CHIU, Xinfeng Township (TW)

(72) Inventors: Chu-Ying HUANG, Kaohsiung City (TW); Lien-Cheng CHANG, Taipei City (TW); Shuo-Ting HUNG, Taoyuan City (TW); Hsuan-Hsiang CHIU, Xinfeng Township (TW)

(21) Appl. No.: 17/526,819

(22) Filed: Nov. 15, 2021

(51) Int. Cl. G10L 25/63; G10L 15/06

(52) U.S. Cl. CPC G10L 25/63; G10L 15/063

(57) ABSTRACT

A method of learning speech emotion recognition is disclosed, and includes receiving and storing raw speech data, performing pre-processing to the raw speech data to generate pre-processed speech data, receiving and storing a plurality of emotion labels, performing processing to the pre-processed speech data according to the plurality of emotion labels to generate processed speech data, inputting the processed speech data to a pre-trained model to generate a plurality of speech embeddings, and training an emotion recognition module according to the plurality of emotion labels and the plurality of speech embeddings.

### BACKGROUND OF THE INVENTION

### 1. Field of the Invention

The invention relates to speech emotion recognition, and more particularly, to a method, system and device of speech emotion recognition and quantization based on deep learning.

### 2. Description of the Prior Art

For the objective quantification of emotions, research scholars, psychologists, and doctors have always hoped to have tools and methods to obtain. In daily life, when we say that a person is sad, but the degree of sadness cannot be described in detail, there is no standard quantitative value to describe emotions. If emotions can be quantitatively analyzed, such as judging the speaker's emotions from his or her expressions, voice prints, and speech content of the speaker, emotion-related applications may become possible. Therefore, after the vigorous development of artificial intelligence technology, a variety of methods have been derived to detect and recognize human emotions, such as facial expression recognition and semantic recognition. However, the method of emotion recognition based on facial expressions and semantic has certain limitations and cannot effectively measure the strengths of different emotions.

The development and limitations of emotion recognition by facial expression: facial recognition is an application of artificial intelligence (AI). In addition to identity recognition, facial recognition can also be used for emotion recognition, with the advantage of not having to speak in judging emotions, but the disadvantage is that people often make facial expressions that do not match his or her actual emotions in order to conceal their true feeling and emotions. In other words, a user can control his or her emotions of facial expressions, cheat and deceive the recognition system. Therefore, the results of emotion recognition using facial expressions are for reference only. For example, the “smiling” and “laughing” facial expressions do not necessarily mean that the latter is happier.

The development and limitations of emotion recognition by speech content: another way to recognize emotions is to recognize emotions based on the content of the speech, which is the so-called semantic analysis. Semantic recognition of emotions belongs to natural language processing (NLP) domain, which is based on the content of the speaker, through semantic analysis techniques to vectorize the vocabulary, in order to interpret the speaker's intent and judge his or her emotions. Judging emotions by speaking content is simple and intuitive, but it is also easy to be misled by the content, because it is easier to people to conceal their true emotions through the content of the speech, or even mislead it into another emotion, so there may be a higher percentage of misjudgments when the content of the speech (meaning) is used to judge the emotion. For example, when people say “I feel good,” it may represent completely opposite emotions in different environments and contexts.

Since the way human expresses his or her emotions is influenced by many subjective factors, the objective quantification of emotions has always been considered difficult to verify, but it is also an important basis for digital industrial applications. Take business services for example, if objective and consistent standards can be established to evaluate emotional status, reduce prejudice caused by personal subjective judgment, allow a merchant to provide appropriate services according to customer's emotion, good customer experience and improvement of customer satisfaction could be made. Therefore, how to provide a method and system of emotion recognition and quantization has become a new topic in the related art.

### SUMMARY OF THE INVENTION

It is therefore an objective of the invention to provide a method of speech emotion recognition based on artificial intelligence deep learning. The method includes receiving and storing raw speech data; performing pre-processing to the raw speech data to generate pre-processed speech data; receiving and storing a plurality of emotion labels; performing processing to the pre-processed speech data according to the plurality of emotion labels to generate processed speech data; inputting the processed speech data to a pre-trained model to generate a plurality of speech embeddings; and training an emotion recognition module according to the plurality of emotion labels and the plurality of speech embeddings.

Another objective of the invention is to provide a system of speech emotion recognition and quantization. The system includes a sound receiving device, a data processing module, an emotion recognition module, and an emotion quantization module. The sound receiving device is configured to generate raw speech data. The data processing module is coupled to the sound receiving device, and configured to performing processing to the raw speech data to generate processed speech data. The emotion recognition module is coupled to the data processing module, and configured to perform emotion recognition to the processed speech data to generate a plurality of emotion recognition results. The emotion quantization module is coupled to the emotion recognition module, and configured to perform statistical analysis to the plurality of emotion recognition results to generate an emotion quantified value.

Another objective of the invention is to provide a device of speech emotion recognition and quantization. The device includes a sound receiving device, a host and a database. The sound receiving device is configured to generate raw speech data. The host is coupled to the sound receiving device, and includes a processor coupled to the sound receiving device; and a user interface coupled to the processor and configured to receive a command. The database is coupled to the host, and configured to store the raw speech data and a program code; wherein, when the command indicates a training mode, the program code instructs the processor to execute the method of learning speech emotion recognition as abovementioned.

In order recognize emotions of a speaker by his or her speech, the invention collects speech data, performs appropriate processing to the speech data and adds on emotion labels, the processed and labelled speech data is presented by time domain, frequency domain or cymatic, and utilizes deep learning techniques to train and establish a speech emotion recognition module or model, the speech emotion recognition module can recognize a speaker's speech emotion classification. Further, the emotion quantization module of the invention can perform statistical analysis to emotion recognition results to generate an emotion quantified value, and the emotion quantization module further recomposes the emotion recognition results on a speech timeline to generate an emotion timing sequence. Therefore, the invention can realize speech emotion recognition and quantization to be applicable to emotion-related emerging applications.

These and other objectives of the present invention will no doubt become obvious to those of ordinary skill in the art after reading the following detailed description of the preferred embodiment that is illustrated in the various figures and drawings.

### BRIEF DESCRIPTION OF THE APPENDED DRAWINGS

FIG. 1 is a functional block diagram of a system of speech emotion recognition and quantization according to an embodiment of the invention.

FIG. 2 is a functional block diagram of a system of speech emotion recognition and quantization operating in the training mode according to an embodiment of the invention.

FIG. 3 is a flowchart of a process of learning speech emotion recognition according to an embodiment of the invention.

FIG. 4 is a flowchart of the step of performing pre-processing to the raw speech data according to an embodiment of the invention.

FIG. 5 is a flowchart of the step of performing processing to the pre-processed speech data according to an embodiment of the invention.

FIG. 6 is a flowchart of the step of performing training to the pre-trained model according to an embodiment of the invention.

FIG. 7 is a functional block diagram of the system of speech emotion recognition and quantization operating in a normal mode according to an embodiment of the invention.

FIG. 8 is a flowchart of a process of speech emotion quantization according to an embodiment of the invention.

FIG. 9 is a schematic diagram of a device for realizing systems of speech emotion recognition and quantization according to an embodiment of the invention.

FIG. 10 is a schematic diagram of emotion quantified value presenting by a pie chart according to an embodiment of the invention.

FIG. 11 is a schematic diagram of emotion quantified value presenting by a radar chart according to an embodiment of the invention.

FIG. 12 is a schematic diagram of emotion timing sequence according to an embodiment of the invention.

### DETAILED DESCRIPTION OF THE INVENTION

Giving a speech is an important way to express human's thoughts and emotions, in addition to speech contents, a speaker's emotion can be recognized from speech characteristics (e.g., timbre, pitch and volume). Accordingly, the invention records audio signals sourced from the speaker, performs data processing to obtain voiceprint data related to speech characteristics, and then extracts speech features such as timbre, pitch and volume in the speech using artificial intelligence deep learning to establish emotion recognition (classification) module. After emotion recognition and classification, statistical analysis is performed to certain emotions that are shown in a period of time to present quantified values of emotions such as a type, strength, frequency, etc.

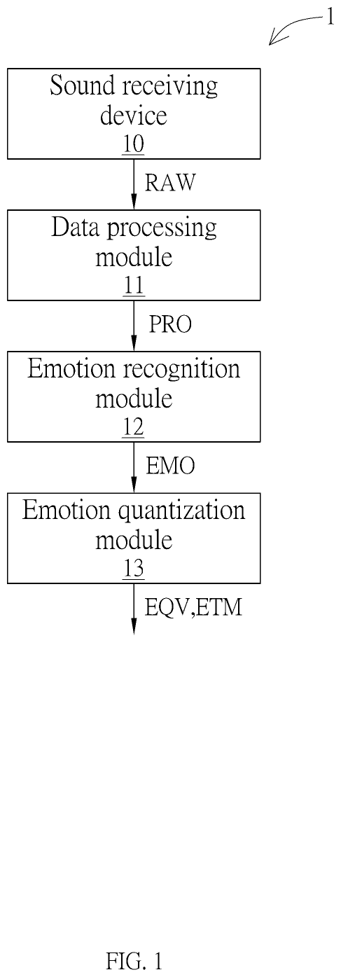

FIG. 1 is a functional block diagram of a system 1 of speech emotion recognition and quantization according to an embodiment of the invention. In structure, the system 1 includes a sound receiving device 10, a data processing module 11, an emotion recognition module 12, and an emotion quantization module 13. The sound receiving device 10 may be any types of sound receiving device, a microphone or a sound recording device, and configured to generate raw speech data RAW.

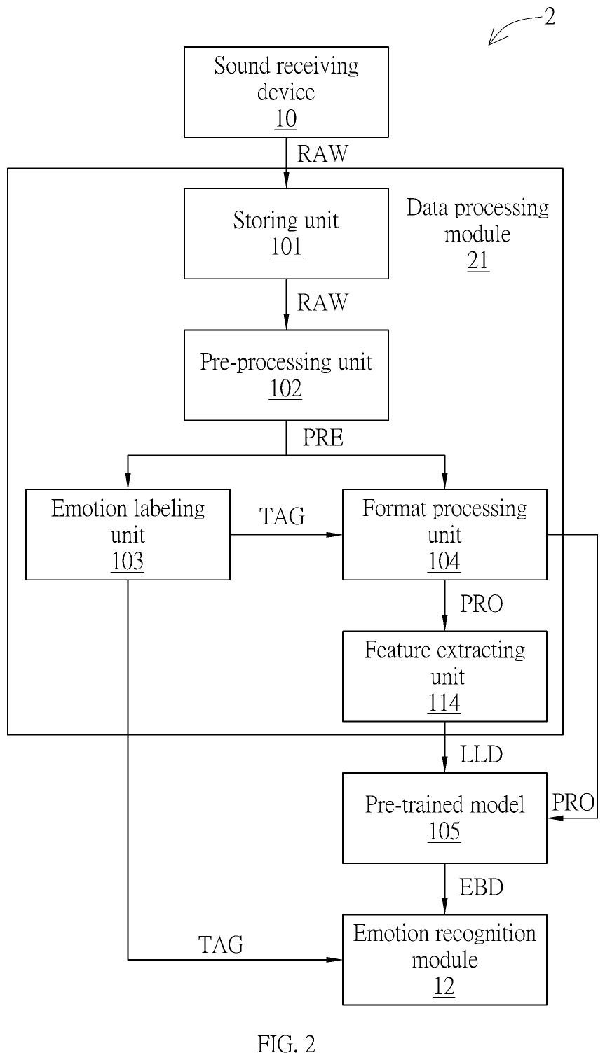

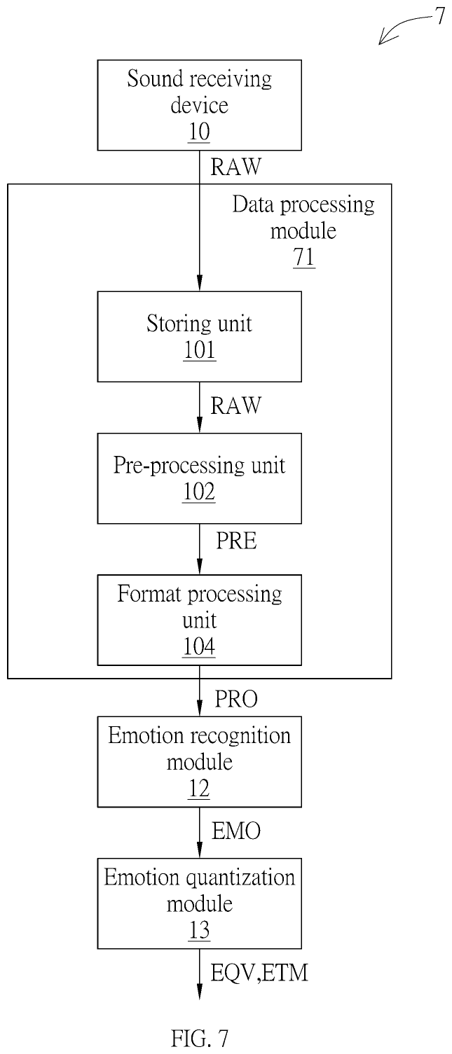

The data processing module 11 is coupled to the sound receiving device 10, and configured to perform processing to the raw speech data RAW to generate processed speech data PRO. The emotion recognition module 12 is coupled to the data processing module 11, and configured to perform emotion recognition to the processed speech data PRO to generate a plurality of the emotion recognition results EMO. The emotion quantization module 13 is coupled to the emotion recognition module 12, and configured to perform statistical analysis to the plurality of the emotion recognition results EMO to generate an emotion quantified value EQV. In one embodiment, the emotion quantization module 13 is further configured to recompose the plurality of the emotion recognition results EMO on a speech timeline to generate an emotion timing sequence ETM. In operation, the system 1 of speech emotion recognition and quantization may operate in a training mode (e.g., the embodiments of FIG. 2 to FIG. 6) or a normal mode (e.g., the embodiments of FIG. 7 to FIG. 12), where the training mode is for training the emotion recognition module 12, while the normal mode is for using the trained emotion recognition module 12 to generate the plurality of the emotion recognition results EMO.

FIG. 2 is a functional block diagram of a system 2 of speech emotion recognition and quantization operating in the training mode according to an embodiment of the invention. The system 2 of speech emotion recognition and quantization in FIG. 2 may replace the system 1 in FIG. 1. In structure, the he system 2 of speech emotion recognition and quantization includes the sound receiving device 10, a data processing module 21, a pre-trained model 105, and the untrained emotion recognition module 12. The data processing module 21 includes a storing unit 101, a pre-processing unit 102, an emotion labeling unit 103, a format processing unit 104, and a feature extracting unit 114.

The storing unit 101 is coupled to the sound receiving device 10, and configured to receive and store the raw speech data RAW. The pre-processing unit 102 is coupled to the storing unit 101, and configured to perform pre-processing to the raw speech data RAW to generate pre-processed speech data PRE. The format processing unit 104 is coupled to the pre-processing unit 102, and configured to perform processing to the pre-processed speech data PRE to generate the processed speech data PRO.

The emotion labeling unit 103 is coupled to the pre-processing unit 102 and the format processing unit 104, and configured to receive and transmit a plurality of emotion labels LAB corresponding to the raw speech data RAW to the format processing unit 104, such that the format processing unit 104 further performs processing to the pre-processed speech data PRE according to the plurality of emotion labels LAB to generate the processed speech data PRO.

The feature extracting unit 114 is coupled to the format processing unit 104, and configured to according to acoustic signal processing algorithms, obtain low-level descriptor data LLD of the pre-processed speech data PRE; wherein the low-level descriptor data LLD includes at least one of a frequency, timbre, pitch, speed and volume.

The pre-trained model 105 is coupled to the feature extracting unit 114 and the emotion recognition module 12, and configured to perform a first phase training and generate a plurality of speech embeddings EBD according to the processed speech data PRO; and perform a second phase training according to the low-level descriptor data LLD. The emotion recognition module 12 is further configured to perform training according to the plurality of emotion labels LAB and plurality of speech embeddings EBD. In one embodiment, the pre-trained model 105 may be models such as Wav2Vec, Hubert and the like, which is not limited in the invention.

In one embodiment, the emotion recognition module 12 may be a deep neural network (DNN) including at least one hidden layer, and the emotion recognition module 12 includes at least one of a linear neural network and a recurrent neural network.

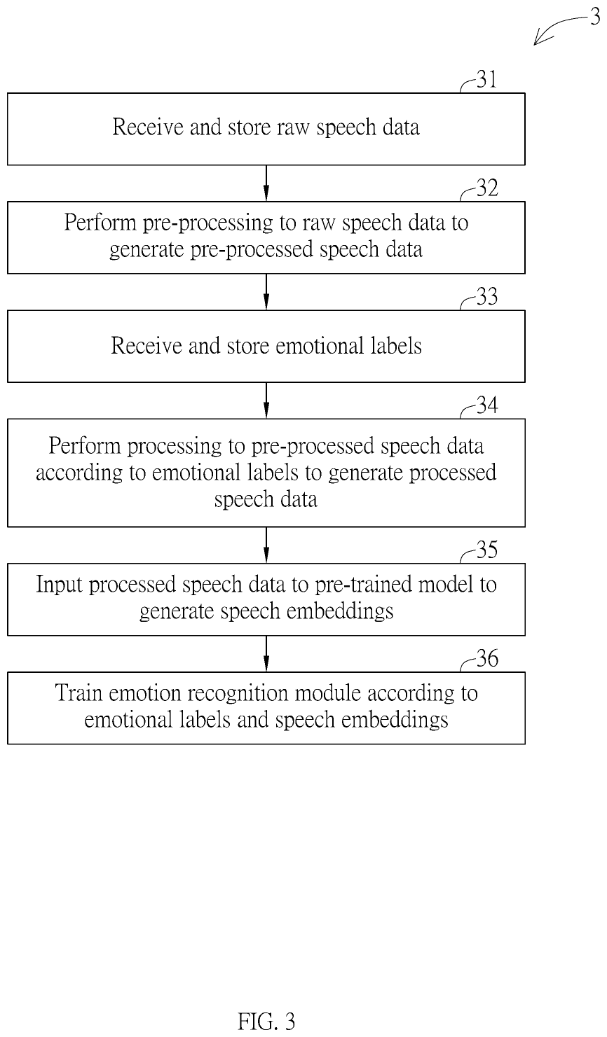

Detailed description regarding the system 2 of speech emotion recognition and quantization operating in the training mode can be obtained by referring to the embodiments of FIG. 3 to FIG. 6. FIG. 3 is a flowchart of a process 3 of learning speech emotion recognition according to an embodiment of the invention. The process 3 may be executed by the system 2 of speech emotion recognition and quantization, and includes the following steps.

Step 31: receive and store raw speech data; step 32: perform pre-processing to the raw speech data to generate pre-processed speech data; step 33: receive and store a plurality of emotion labels; step 34: perform processing to the pre-processed speech data according to the plurality of emotion labels to generate processed speech data; step 35: input the processed speech data to a pre-trained model, to generate a plurality of speech embeddings; and step 36: train an emotion recognition module according to the plurality of emotion labels and the plurality of speech embeddings.

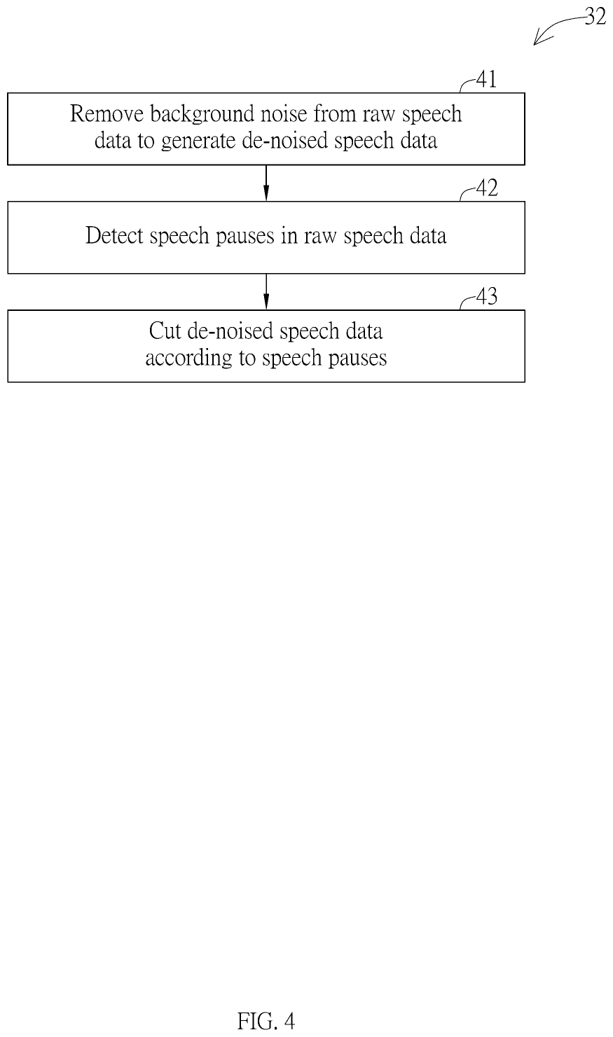

In detail, in the step 31, the storing unit 101 receiving and storing the raw speech data RAW; In one embodiment, the storing unit 101 stores the raw speech data RAW by lossless compression. In the step 32, the pre-processing unit 102 performs pre-processing to the raw speech data RAW to generate the pre-processed speech data PRE; please refer to the embodiment of FIG. 4 for detailed description regarding the step 32.

In the step 33, the emotion labeling unit 103 receives and stores the plurality of emotion labels LAB. In order to obtain objective labelled results, applicant invites at least one professional to label the types of emotion for the same a speech file (e.g., the raw speech data RAW); when there is any prominent disagreement for the labelled results, the speech file will be discussed thoroughly, to ensure consistency and correctness of the labelled results.

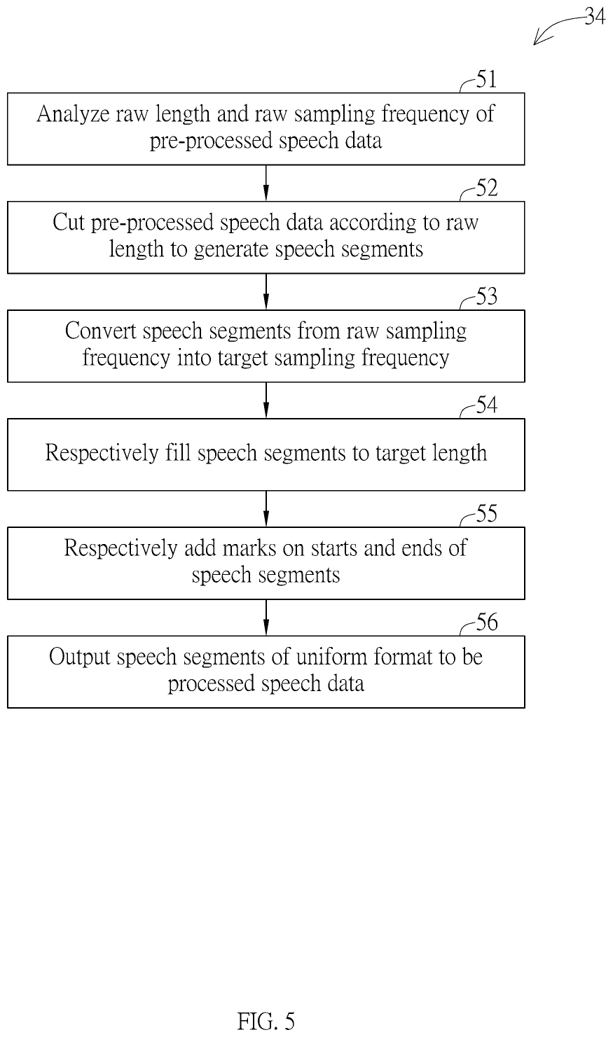

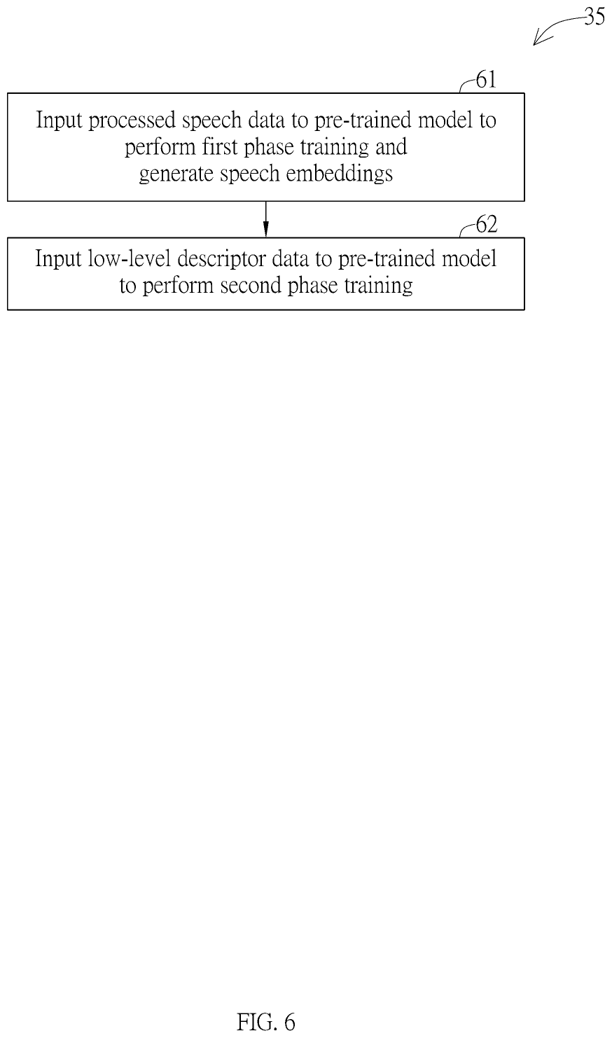

In the step 34, the format processing unit 104 performs processing to the pre-processed speech data PRE according to the plurality of emotion labels LAB, to generate the processed speech data PRO; please refer to the embodiment of FIG. 5 for detailed description regarding the step 34. In the step 35, the format processing unit 104 inputs the processed speech data PRO to the pre-trained model 105, such that the pre-trained model 105 generates the plurality of speech embeddings EBD; please refer to the embodiment of FIG. 6 for detailed description regarding the step 35. In the step 36, the emotion recognition module 12 performs training according to the plurality of emotion labels LAB and the plurality of speech embeddings EBD.

FIG. 4 is a flowchart of the step 32 of performing pre-processing to the raw speech data according to an embodiment of the invention. As shown in FIG. 4, the step 32 may be executed by the pre-processing unit 102, and includes step 41: remove background noise from raw speech data to generate de-noised speech data; step 42: detect a plurality of speech pauses in the raw speech data; and step 43: cut the de-noised speech data according to the plurality of speech pauses.

In practice, since there may be various noises (e.g., other people's voice, device noise, and the like) in a sound receiving environment, it is crucial to remove background noise and reserve clear main voice before performing emotion recognition, which may improve an accuracy of emotion recognition. In one embodiment, removal of background noise may be a manner that includes performing Fourier transform to the raw speech data RAW to convert the raw speech data RAW from a time domain expression into a frequency domain expression; filtering out frequency components corresponding to the background noise from the raw speech data RAW; and converting the filtered raw speech data RAW back to the time domain expression to generate the de-noised speech data.

Further, in order to make the meaning clear, adjust rhythm, change breath, etc., the speaker often pauses when speaking, and expresses his or her thoughts and emotions completely after stating a paragraph. Accordingly, in order to analyze the emotion corresponding to the sentence segments (between two pauses) of the speech microscopically, it is necessary to detect a plurality of pauses in the raw speech data RAW, and then cut the speech data according to the plurality of pauses. As a result, the plurality of emotion recognition results EMO corresponding to a plurality of sentence segments are statistically analyzed, and what kind of emotion distribution and a trend of a paragraph of the speaker corresponds to can be analyzed macroscopically.

FIG. 5 is a flowchart of the step 34 of performing processing to the pre-processed speech data PRE according to an embodiment of the invention. The step 34 may be executed by the format processing unit 104, and includes step 51: analyze a raw length and a raw sampling frequency of pre-processed speech data; step 52: cut the pre-processed speech data according to the raw length to generate a plurality of speech segments; step 53: convert the plurality of speech segments from a raw sampling frequency into a target sampling frequency; step 54: respectively fill the plurality of speech segments to a target length; step 55: respectively add marks on a plurality of starts and a plurality of ends of the plurality of speech segments; and step 56: output the plurality of speech segments of uniform format to be the processed speech data.

In one embodiment, the target sampling frequency is greater than or equal to 16 KHz; or the target sampling frequency is a highest sampling frequency or a Nyquist Frequency of the sound receiving device 10. For example, a sampling frequency of a Compact Disc (CD) audio signal is 44.1 KHz, then the Nyquist Frequency of the CD audio signal is 22.05 KHz.

In order to effectively increase the number of training samples such that classes of emotions can reach data balance, the invention cuts the collected data set (i.e., the pre-processed speech data PRE, or the raw speech data RAW) by a fixed time length, and a cutting length is adjustable according to practical requirements. In one embodiment, at least one cutting length for cutting the pre-processed speech data PRE is at least two seconds. In one embodiment, a cutting length for cutting the pre-processed speech data PRE is an averaged length. It should be noted that the cut plurality of speech segments and the raw speech data RAW (or the pre-processed speech data PRE) correspond to the same plurality of emotion labels LAB.

In one embodiment, the step 54 of respectively fill the plurality of speech segments to the target length includes: when a length of a speech segment of the plurality of speech segments is shorter than the target length, add null data on the speech segment; and when the length of the speech segment is longer than the target length, trim the speech segment to the target length. In one embodiment, the added null data is binary bit “0”, which is not limited. In one embodiment, the target length may be a longest speech segments or a self-defined length of the data set (i.e., the pre-processed speech data PRE, or the raw speech data RAW). In one embodiment, the pre-processed speech data PRE and the processed speech data PRO utilized in the invention may be presented by time domain, frequency domain or cymatic expression.

In short, by the format processing unit 104 executing the steps 51 . . . 56, the plurality of speech segments of uniform format may be generated to meet input requirements for the pre-trained model 105.

In one embodiment, the step 34 further includes a step after the step 56: obtain low-level descriptor data of the plurality of speech segments [symbol] according to acoustic signal processing algorithms; wherein the low-level descriptor data includes at least one of a frequency, timbre, pitch, speed and volume. The step may be executed by the feature extracting unit 114. In one embodiment, the feature extracting unit 114 may utilize Fourier transform or Short-Term Fourier Transform (STFT) and other manners thereon based to obtain data converted from time domain to frequency domain. Further, the feature extracting unit 114 may utilize appropriate audio processing techniques, e.g., obtain the low-level descriptor data LLD of the plurality of speech segments according to Mel-scale filters and Mel-Frequency Cepstral Coefficients (MFCC), for the following training for the pre-trained model 105.

FIG. 6 is a flowchart of the step 35 of performing training to the pre-trained model according to an embodiment of the invention. The step 35 may be executed by the pre-trained model 105, and includes step 61: input the processed speech data to the pre-trained model to perform a first phase training and generate a plurality of speech embeddings; and step 62: input the low-level descriptor data to the pre-trained model to perform a second phase training. It should be noted that the first phase training aims at obtaining the plurality of speech embeddings EBD representing multiple features of a speech, while the second phase training aims at fine-tuning training to improve the plurality of speech embeddings EBD in performing the following emotion recognition and classification. That is to say, after two phases of training, collective meanings of inputted speech data and individual meanings of those low-level descriptor data LLD are given to the plurality of speech embeddings EBD. Therefore, after the emotion recognition module 12 is trained according to the plurality of emotion labels LAB and the plurality of speech embeddings EBD (step 36), the emotion recognition module 12 can discriminate collective and individual meanings represented by the speech embeddings of the inputted speech data to perform emotion recognition and classification, so as to improve accuracy.

FIG. 7 is a functional block diagram of the system 7 of speech emotion recognition and quantization operating in a normal mode according to an embodiment of the invention. The system 7 of speech emotion recognition and quantization in FIG. 7 may replace the system 1 in FIG. 1. From another point of view, a portion of elements of the system 2 in FIG. 2 are disabled to form the architecture of the system 7, and thus structural description regarding the system 7 may be obtained by referring to the embodiment of FIG. 2. speech emotion recognition and quantization system 7 includes the sound receiving device 10, a data processing module 71, the emotion recognition module 12 and the emotion quantization module 13. The data processing module 71 includes the storing unit 101, the pre-processing unit 102 and the format processing unit 104.

In operation, the sound receiving device 10 receives the raw speech data RAW and transmits to the data processing module 71; the data processing module 71 performs data storing, pre-processing (de-noise) and format processing unit respectively by the storing unit 101, the pre-processing unit 102 and the format processing unit 104 to generate the processed speech data PRO of uniform format, in order to meet input requirements for the emotion recognition module 12; the emotion recognition module 12 performs emotion recognition to the processed speech data PRO to generate the plurality of the emotion recognition results EMO; and the emotion quantization module 13 performs statistical analysis to the plurality of the emotion recognition results EMO to generate the emotion quantified value EQV.

As a result, by the embodiments of FIG. 1 to FIG. 7 of the invention, speech emotion recognition and quantization may be realized to be applicable to emotion-related emerging applications; e.g., a merchant can provide appropriate services according to customer's emotion, to provide well customer experience and improve customer satisfaction.

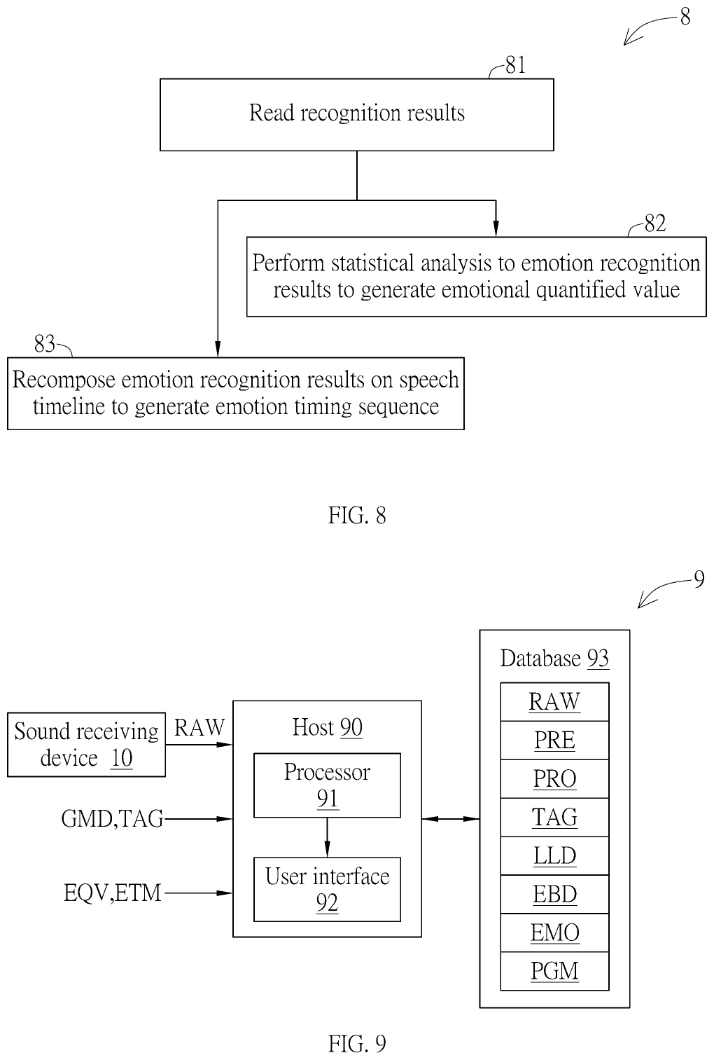

FIG. 8 is a flowchart of a process 8 of speech emotion quantization according to an embodiment of the invention. The process 8 may be executed by the emotion quantization module 13, and includes step 81: read a plurality of emotion recognition results; step 82: perform statistical analysis to the plurality of emotion recognition results to generate emotion quantization values; and step 83: recompose the plurality of emotion recognition results on a speech timeline to generate an emotion timing sequence.

In detail, in the step 81, the emotion quantization module 13 reads the plurality of the emotion recognition results EMO from the emotion recognition module 12 (or a memory). In the step 82, the emotion quantization module 13 performs statistical analysis to the plurality of the emotion recognition results EMO to generate the emotion quantization values EQV. For example, the emotion quantization module 13 calculates times, strength, frequency, and the like of multiple emotions that are recognized in a period of time (e.g., all or a part of recording time of the raw speech data RAW) to compute percentages of the multiple emotions, and then calculates the emotion quantization values EQV according to the percentages and corresponding to reference value of the multiple emotions. In the step 83, the emotion quantization module 13 recomposes the plurality of the emotion recognition results EMO on a speech timeline to generate the emotion timing sequence ETM; as a result, a trend of emotion variating as time for the speaker can be seen from the emotion timing sequence ETM.

FIG. 9 is a schematic diagram of a device 9 for realizing the systems 1, 2, 7 of speech emotion recognition and quantization according to an embodiment of the invention. The device 9 may be an electronic device having functions of computation and storing, such as a smart phone, smart watch, tablet computer, desk computer, robot, server, etc., which is not limited. The sound receiving device 10 may be external to or built in the device 9, and configured to generate the raw speech data RAW. The device 9 includes a host 90 and a database 93, wherein the host 90 includes a processor 91 and a user interface 92. The processor 91 is coupled to the sound receiving device 10, and may be an integrated circuit (IC), a microprocessor, an application specific integrated circuit (ASIC), etc., which is not limited. The user interface 92 is coupled to the processor 91, and configured to receive a command CMD; and the user interface 92 may be at least one of a display, a keyboard, a mouse, and other peripheral devices, which is not limited. The database 93 is coupled to the host 90 is configured to store the raw speech data RAW and a program code PGM; and the database 93 may be a memory or a cloud database external to or built in the device 9, for example but not limit to a volatile memory, non-volatile memory, compact disk, magnetic tape, etc. In one embodiment, the host 90 further includes a network communication interface; the host 90 may access Internet by wired or wireless communication to connect to a cloud service system in order to perform speech emotion recognition and quantization by the cloud service system, and the cloud service system transmits recognition results back to the host 90, which is also known as Software as a Service (SaaS). The processes and steps as mentioned in the above embodiments may be compiled into the program code PGM for instructing the processor 91 or the cloud service system to perform speech emotion training, recognition, and quantization.

When the command CMD indicates the training mode, the program code PGM instructs the processor 91 to execute the system architecture, operations, processes and steps of the embodiments of FIG. 2 to FIG. 6, the user interface 92 is configured to receive the plurality of emotion labels LAB, and the database 93 is configured to store all data required for and generated from the training mode (i.e., the raw speech data RAW, the pre-processed speech data PRE, the processed speech data PRO, the plurality of emotion labels LAB, the low-level descriptor data LLD, the embeddings EBD, and the like).

When the command CMD indicates the normal mode, the program code PGM instructs the processor 91 to execute he system architecture, operations, processes and steps of the embodiments of FIG. 7 and FIG. 8, the user interface 92 is configured to output the emotion recognition results EMO and the emotion timing sequence ETM, and the database 93 is configured to store all data required for and generated from the normal mode (i.e., the raw speech data RAW, the pre-processed speech data PRE, the processed speech data PRO, the emotion recognition results EMO, the emotion quantified value EQV, the emotion timing sequence ETM, and the like).

As a result, by the embodiment of FIG. 9 of the invention, speech emotion recognition and quantization may be realized by various devices to be applicable to emotion-related emerging applications; e.g., a merchant may deploy a robot in a marketplace for providing appropriate services according to customer's emotion, to provide well customer experience and improve customer satisfaction.

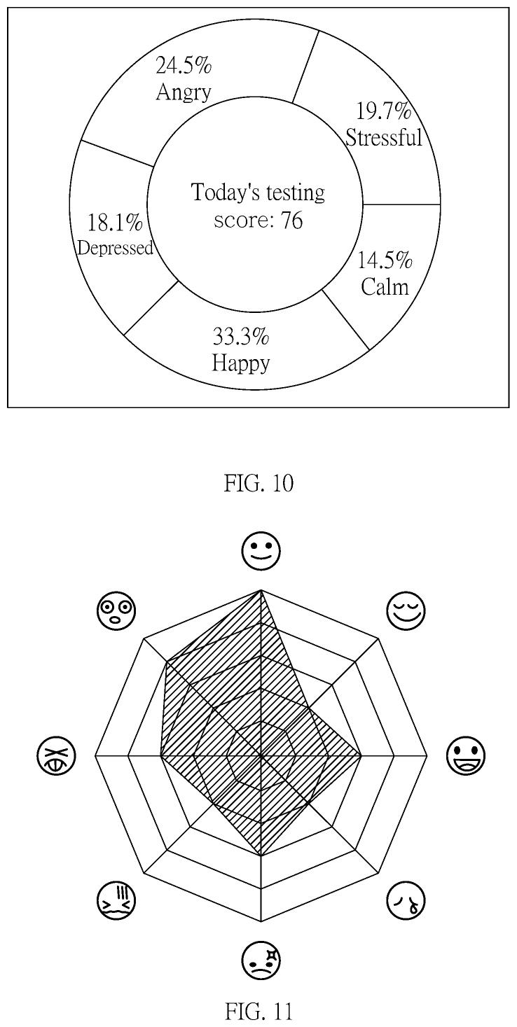

FIG. 10 is a schematic diagram of emotion quantified value presenting by a pie chart according to an embodiment of the invention. As shown in FIG. 10, after speech emotion recognition and quantization, percentages of multiple emotions of “angry, stressed, calm, happy, depressed” are respectively obtained as 24.5%, 19.7%, 14.5%, 23.3%, 18.1%, and the emotion quantified score is further calculated to be 76.

FIG. 11 is a schematic diagram of emotion quantified value presenting by a radar chart according to an embodiment of the invention. As shown in FIG. 11, after speech emotion recognition and quantization, it can be seen from the radar chart strength comparisons between multiple emotions (for example but mot limit to eight emotions).

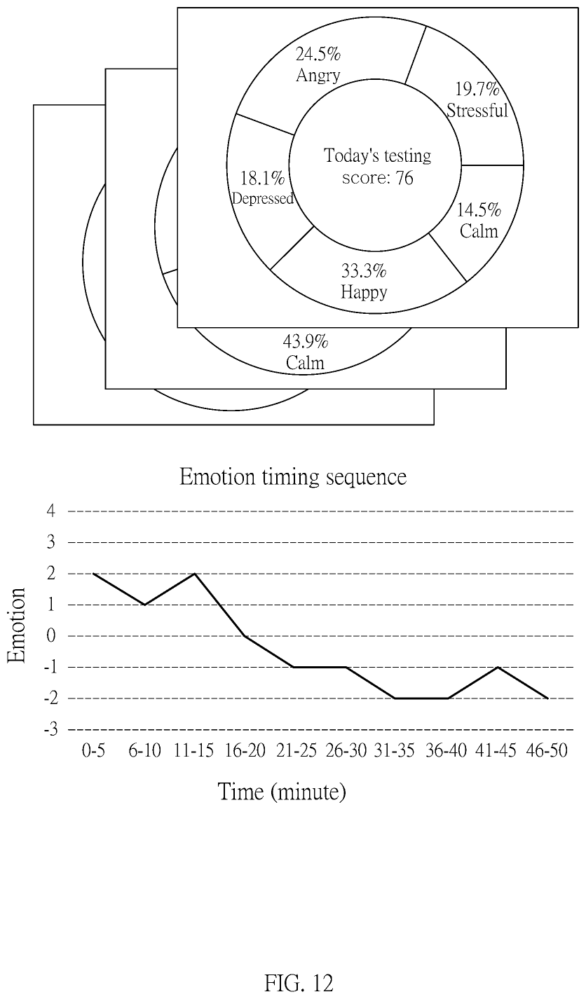

FIG. 12 is a schematic diagram of emotion timing sequence according to an embodiment of the invention. Given that reference values corresponding to multiple emotions are shown in the following Table. After the emotion recognition results have been recomposed on the speech timeline, a trend of emotion variating as time can be seen from the emotion timing sequence in FIG. 12. In certain applications, by observing emotion timing sequences of the same speaker under different period of times and taking reference to other conditions or parameters (e.g., day or night, season, physiological parameters such as body temperature, heart rate, respiration rate of the speaker), mental states of the speaker may be further analyzed.

TABLE

| Emotion | Reference Value |
|---|---|
| Angry | 4 |
| Fearful | 3 |
| Disgust | 2 |
| Happy | 1 |
| Peaceful | 0 |
| Calm | −1 |
| Surprised | −2 |
| Depressed | −3 |

To sum up, in order recognize emotions of a speaker by his or her speech, the invention collects speech data, performs appropriate processing to the speech data and adds on emotion labels, the processed and labelled speech data is presented by time domain, frequency domain or cymatic, and utilizes deep learning techniques to train and establish a speech emotion recognition module or model, the speech emotion recognition module can recognize a speaker's speech emotion classification. Further, the emotion quantization module of the invention can perform statistical analysis to emotion recognition results to generate an emotion quantified value, and the emotion quantization module further recomposes the emotion recognition results on a speech timeline to generate an emotion timing sequence. Therefore, the invention can realize speech emotion recognition and quantization to be applicable to emotion-related emerging applications.

Those skilled in the art will readily observe that numerous modifications and alterations of the device and method may be made while retaining the teachings of the invention. Accordingly, the above disclosure should be construed as limited only by the metes and bounds of the appended claims.

1. A method of learning speech emotion recognition, comprising:
receiving and storing raw speech data;
performing pre-processing to the raw speech data to generate pre-processed speech data;
receiving and storing a plurality of emotion labels;
performing processing to the pre-processed speech data according to the plurality of emotion labels to generate processed speech data;
inputting the processed speech data to a pre-trained model to generate a plurality of speech embeddings; and
training an emotion recognition module according to the plurality of emotion labels and the plurality of speech embeddings.

2. The method of claim 1, wherein the step of performing pre-processing to the raw speech data to generate the pre-processed speech data comprises:
removing background noise from the raw speech data to generate de-noised speech data;
detecting a plurality of speech pauses in the raw speech data; and
cutting the de-noised speech data according to the plurality of speech pauses.

3. The method of claim 1, wherein the step of performing processing to the pre-processed speech data to generate the processed speech data comprises:
analyzing a raw length and a raw sampling frequency of the pre-processed speech data;
cutting the pre-processed speech data according to the raw length to generate a plurality of speech segments;
converting the plurality of speech segments from the raw sampling frequency into a target sampling frequency;
respectively filling the plurality of speech segments to a target length;
respectively adding marks on a plurality of starts and a plurality of ends of the plurality of speech segments; and
outputting the plurality of speech segments of uniform format to be the processed speech data.

4. The method of claim 3, wherein the plurality of speech segments and the raw speech data correspond to the same plurality of emotion labels.

5. The method of claim 3, wherein the target sampling frequency is greater than or equal to 16 KHz; or the target sampling frequency is a highest sampling frequency or a Nyquist Frequency of a sound receiving device.

6. The method of claim 3, wherein at least one cutting length for cutting the pre-processed speech data is at least two seconds.

7. The method of claim 3, wherein the step of respectively filling the plurality of speech segments to the target length comprises:
when a length of a speech segment of the plurality of speech segments is shorter than the target length, adding null data on the speech segment; and
when the length of the speech segment is longer than the target length, trimming the speech segment to the target length.

8. The method of claim 3, wherein the step of performing processing to the pre-processed speech data to generate the processed speech data further comprises:
obtaining low-level descriptor data of the plurality of speech segments according to acoustic signal processing algorithms;
wherein the low-level descriptor data includes at least one of a frequency, timbre, pitch, speed, and volume.

9. The method of claim 8, wherein the step of inputting the processed speech data to the pre-trained model to generate the plurality of speech embeddings comprises:
inputting the processed speech data to the pre-trained model to perform a first phase training and generate the plurality of speech embeddings; and
inputting the low-level descriptor data to the pre-trained model to perform a second phase training.

10. The method of claim 1, wherein the emotion recognition module comprises at least one hidden layer, and the emotion recognition module comprises at least one of a linear neural network and a recurrent neural network.

11. A system of speech emotion recognition and quantization, comprising:
a sound receiving device configured to generate raw speech data;
a data processing module coupled to the sound receiving device, and configured to performing processing to the raw speech data to generate processed speech data;
an emotion recognition module coupled to the data processing module, and configured to perform emotion recognition to the processed speech data to generate a plurality of emotion recognition results; and
an emotion quantization module coupled to the emotion recognition module, and configured to perform statistical analysis to the plurality of emotion recognition results to generate an emotion quantified value.

12. The system of claim 11, wherein, when operating in a normal mode, the data processing module comprising:
a storing unit coupled to the sound receiving device, and configured to receive and store the raw speech data;
a pre-processing unit coupled to the storing unit, and configured to perform pre-processing to the raw speech data to generate pre-processed speech data; and
a format processing unit coupled to the pre-processing unit, and configured to perform processing to the pre-processed speech data to generate the processed speech data.

13. The system of claim 12, wherein the emotion recognition module is trained according to a method of learning speech emotion recognition comprising:
receiving and storing raw speech data;
performing pre-processing to the raw speech data to generate pre-processed speech data;
receiving and storing a plurality of emotion labels;
performing processing to the pre-processed speech data according to the plurality of emotion labels to generate processed speech data;
inputting the processed speech data to a pre-trained model to generate a plurality of speech embeddings; and
training an emotion recognition module according to the plurality of emotion labels and the plurality of speech embeddings.

14. The system of claim 13, wherein, when operating in a training mode, the data processing module further comprising:
an emotion labeling unit coupled to the pre-processing unit and the format processing unit, and configured to receive and transmit a plurality of emotion labels corresponding to the raw speech data to the format processing unit, such that the format processing unit further performs processing to the pre-processed speech data according to the plurality of emotion labels to generate the processed speech data; and
a feature extracting unit coupled to the format processing unit, and configured to obtain low-level descriptor data of the pre-processed speech data according to acoustic signal processing algorithms;
wherein the low-level descriptor data includes at least one of a frequency, timbre, pitch, speed, and volume.

15. The system of claim 14, when operating in the training mode, further comprising:
a pre-trained model coupled to the feature extracting unit and the emotion recognition module, and configured to perform a first phase training and generate the plurality of speech embeddings according to the processed speech data; and perform a second phase training according to the low-level descriptor data.

16. The system of claim 14, wherein, when operating in the training mode, the emotion recognition module is further configured to perform training according to the plurality of emotion labels and the plurality of speech embeddings.

17. The system of claim 11, wherein, when operating in the normal mode, the emotion quantization module is further configured to recompose the plurality of emotion recognition results on a speech timeline to generate an emotion timing sequence.

18. A device of speech emotion recognition and quantization, comprising:
a sound receiving device configured to generate raw speech data;
a host coupled to the sound receiving device, comprising:
a processor coupled to the sound receiving device; and
a user interface coupled to the processor, and configured to receive a command; and
a database coupled to the host, and configured to store the raw speech data and a program code;
wherein, when the command indicates a training mode, the program code instructs the processor to execute the method of learning speech emotion recognition of claim 1.

19. The device of claim 18, wherein, when the command indicates the training mode, the user interface is configured to receive a plurality of emotion labels, and the database is configured to store all data required for and generated from the training mode.

20. The device of claim 18, wherein, when the command indicates a normal mode:
the program code instructs the processor to execute the following steps to generate a plurality of emotion recognition results;
wherein the step of performing pre-processing to the raw speech data to generate the pre-processed speech data comprises:
removing background noise from the raw speech data to generate de-noised speech data;
detecting a plurality of speech pauses in the raw speech data; and
cutting the de-noised speech data according to the plurality of speech pauses;
wherein the step of performing processing to the pre-processed speech data to generate the processed speech data comprises:
analyzing a raw length and a raw sampling frequency of the pre-processed speech data;
cutting the pre-processed speech data according to the raw length to generate a plurality of speech segments;
converting the plurality of speech segments from the raw sampling frequency into a target sampling frequency;
respectively filling the plurality of speech segments to a target length;
respectively adding marks on a plurality of starts and a plurality of ends of the plurality of speech segments; and
outputting the plurality of speech segments of uniform format to be the processed speech data
wherein the plurality of speech segments and the raw speech data correspond to the same plurality of emotion labels;
wherein the target sampling frequency is greater than or equal to 16 KHz; or the target sampling frequency is a highest sampling frequency or a Nyquist Frequency of a sound receiving device;
wherein at least one cutting length for cutting the pre-processed speech data is at least two seconds;
wherein the step of respectively filling the plurality of speech segments to the target length comprises:
when a length of a speech segment of the plurality of speech segments is shorter than the target length, adding null data on the speech segment; and
when the length of the speech segment is longer than the target length, trimming the speech segment to the target length;
wherein the step of performing processing to the pre-processed speech data to generate the processed speech data further comprises:
obtaining low-level descriptor data of the plurality of speech segments according to acoustic signal processing algorithms;
wherein the low-level descriptor data includes at least one of a frequency, timbre, pitch, speed, and volume;
the program code further instructs the processor to perform statistical analysis to the plurality of emotion recognition results to generate an emotion quantified value;
the program code further instructs the processor to recompose the plurality of emotion recognition results on a speech timeline to generate an emotion timing sequence;
the user interface is configured to output the emotion quantified value and the emotion timing sequence; and
the database is configured to store all data required for and generated from the normal mode.
